(19) United States
(12) Patent Application Publication
(10) Pub. No.: US 2025/0277159 A1
(43) Pub. Date: Sep. 4, 2025

(54) HIGH TEMPERATURE LUBRICANTS FOR MAGNETIC MEDIA HAVING MORE THERMALLY STABLE END GROUPS

(71) Applicant: Western Digital Technologies, Inc., San Jose, CA (US)

(72) Inventors: Daniel Demori Maksuta, San Jose, CA (US); Jianming Wen, Pleasanton, CA (US); Charles Cheng-Hsing Lee, San Jose, CA (US)

(21) Appl. No.: 18/593,481

(22) Filed: Mar. 1, 2024

(51) Int. Cl. C10M 105/54; G11B 5/00; G11B 5/725

(52) U.S. Cl. CPC C10M 105/54; G11B 5/7257; C10M 2207/003; G11B 2005/0021

(57) ABSTRACT

High temperature lubricants for magnetic media are provided. One such lubricant includes an end group having a constituent with a higher rotational energy barrier than CH₂. The constituent with the higher rotational energy barrier can be benzene or anisole. The lubricants can be used in conjunction with a magnetic recording medium and/or a magnetic data storage system. The end group is not restricted to a dihydroxy propyl configuration. The anchoring groups can be farther away from the group having a higher rotational energy barrier than CH₂, for example:

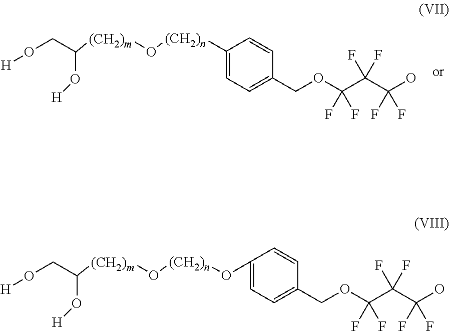

where n is 0 to 10 and m is 1 to 10.

### FIELD

The disclosure relates to lubricants, and more particularly, to high temperature lubricants, which may be used with media configured for magnetic recording, e.g., for Heat Assisted Magnetic Recording (HAMR) having more thermally stable end groups.

### INTRODUCTION

Magnetic storage systems, such as a hard disk drive (HDD), are utilized in a wide variety of devices in both stationary and mobile computing environments. Examples of devices that incorporate magnetic storage systems include data center storage systems, desktop computers, portable notebook computers, portable hard disk drives, network storage systems, high definition television (HDTV) receivers, vehicle control systems, cellular or mobile telephones, television set top boxes, digital cameras, digital video cameras, video game consoles, and portable media players.

A typical disk drive includes magnetic storage media in the form of one or more flat disks or platters. The disks generally include two main components, namely, a substrate material that gives it structure and rigidity, and a magnetic medium coating that stores the magnetic signals that represent data in a recording layer within the coating. The typical disk drive also includes a read head and a write head, generally in the form of a magnetic transducer which can sense and/or change the magnetic fields stored on the recording layer of the disks. HAMR is a recording technique that can increase the areal density capability (ADC) of written data on a magnetic storage medium having very high coercivity with high-temperature assistance. However, the high recording temperatures applied to the medium may present challenges. Other examples of magnetic storage media include flexible tape media usable for magnetic tape recording.

As a result of the high temperatures associated with HAMR technology, suitable lubricants for use in HAMR media may benefit from high thermal stability. In addition, the higher temperatures also increase the presence of contaminants which may negatively affect data storage. However, high temperatures may cause thermally activated reactions such as decomposition and polymerization which will cause discoloring, i.e., fogging, of the storage medium. It is desirable to find lubricant chemistries that will inhibit thermally activated reactions while maintaining high evaporation temperature. As such, there is a need in the art for high temperature lubricants having properties suitable for use in HAMR drives, including the ability to sequester and/or remove contaminants prior to the contaminants interfering with data storage or other operational processes.

### SUMMARY

In one aspect, this disclosure provides a lubricant comprising: a plurality of segments according to general formula (I), (II), or (III):

Re¹—Rb¹-Rc-Rb²—Re² (I);

Re¹—Rb¹—Re² (II); or

Re¹—Rb¹—(Rc-Rb²)ₘ-Re² (III);
wherein Rc, when present, is a divalent linking segment that optionally includes a first anchoring functional group engageable with a protective overcoat of a magnetic recording medium;
wherein each Rb¹ and Rb², when present, independently comprises a chain segment comprising at least one of a fluoroalkyl ether moiety, a fluoroalkenyl ether moiety, a perfluoroalkyl ether moiety, a perfluoroalkenyl ether moiety, or a combination thereof;
wherein each of Re¹ and Re² independently comprises a group having a higher rotational energy barrier than that of CH₂, terminating with at least one second anchoring functional group engageable with the protective overcoat of the magnetic recording medium comprising —CH₂OCH₂(CH₂)ₙ(Ra)ₙ₋₁ or —OCH₂(CH₂)ₙ(Ra)ₙ₋₁, wherein Ra is the second anchoring functional group and n=1-10.

In one aspect, the lubricant described above wherein the first and second anchoring functional groups independently each comprises at least one of B, Si, a pnictogen, a chalcogen, a halogen, —OR*, —NR*₂, —NR*—CO—R*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure.

In one aspect, the lubricant described above wherein the first and second anchoring functional groups each comprises a hydroxyl (—OH) moiety.

In one aspect, the lubricant described above wherein Re¹ and Re² independently comprises —OCF₂(CF₂)ₘ—O—CH₂ArRt wherein Rt is —CH₂OCH₂(CH₂)ₙ(Ra)ₙ₋₁ or Rt is —OCH₂(CH₂)ₙ(Ra)ₙ₋₁, Ar is an aromatic group and Ra is the second anchoring functional group.

In one aspect, the lubricant described above wherein the group having a higher rotational energy barrier than that of CH₂ is an aromatic group.

In one aspect, the lubricant described above wherein the group having a higher rotational energy barrier than that of CH₂ is benzene or anisole.

In one aspect, the lubricant described above wherein the first and second anchoring functional groups independently comprises one or more of B, Si, a pnictogen, a chalcogen, a halogen, —OH, —NH₂, —NH—CO—H, —O—CO—H, —CO—O—H, —SeH, —TeH, —PH₂, —PO—(OH)₂, —O—PO—(OH)₂, —N=P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof, wherein q is 1 to 10.

In one aspect, the lubricant described above wherein Re¹ and Re² are independently selected from the group consisting of:

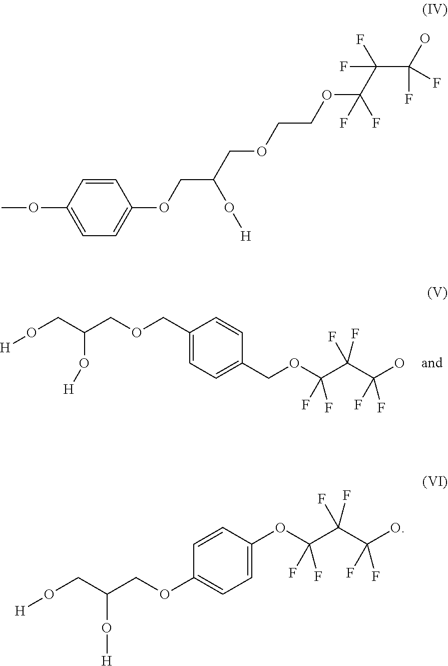

In one aspect, the lubricant described above wherein Re¹ and Re² are independently selected from the group consisting of:

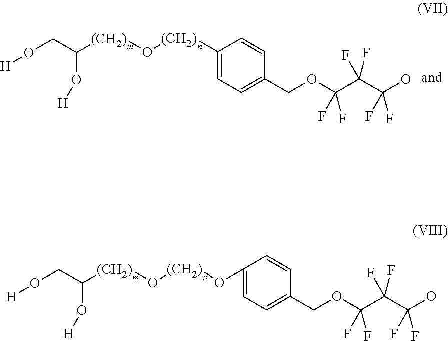

wherein n is 0 to 10 and m is 1 to 10.

In one aspect, the lubricant described above which comprises the general formula (XVII):

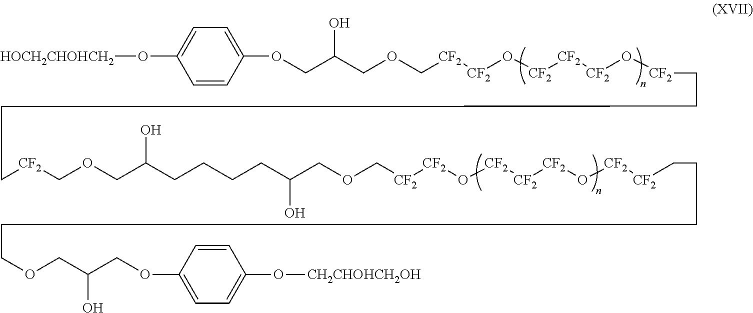

where n=1-10.

In one aspect, the lubricant described above which comprises the general formula (XVIII):

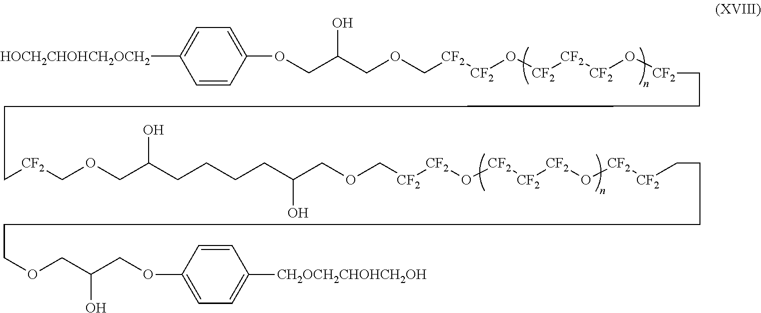

where n=1-10.

In one aspect, the lubricant described above wherein Rc, when present, comprises general formula (IXX):

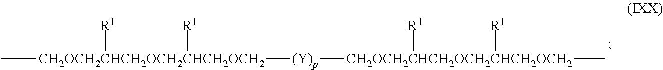

wherein each Y independently comprises:
(i) —CH₂—;
(ii) —CF₂—;
(iii) —CHF—;
(iv) —CF₂CF₂CF₂O(CF₂CF₂CF₂CF₂O)ₐCF₂CF₂CF₂—;
(v) —CF₂CF₂O(CF₂CF₂CF₂O)ₐCF₂CF₂—;
(vi) —CF₂CF₂O[CF(CF₃)CF₂O]ₐCF₂CF₂—;
(vii) —CF₂O(CF₂CF₂O)ₐ(CF₂O)_{b}CF₂—;
(viii) —CF₂O(CF₂CF₂O)ₐCF₂—;
   or a combination thereof;
wherein each a, when present, is independently from 1 to 20,
wherein each b, when present, is independently from 1 to 20;
wherein p is from 1 to 20; and
wherein at least one R¹ when present is an anchoring functional group engageable with a protective overcoat of a magnetic recording medium, comprising B, Si, a pnictogen, a chalcogen, a halogen, —OR*, —NR*₂, —NR*—CO—R*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure.

In one aspect, the lubricant described above wherein Rc, when present, comprises general formula (XX):

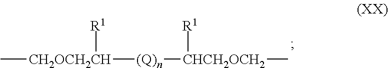

wherein each Q independently comprises:
(i) —CH₂—;
(ii) —CF₂—;
(iii) —CHF—;
(iv) —CF₂CF₂CF₂(CF₂CF₂CF₂CF₂O)ₐCF₂CF₂CF₂—;
(v) —CF₂CF₂O(CF₂CF₂CF₂O)ₐCF₂CF₂—;
(vi) —CF₂CF₂O[CF(CF₃)CF₂O]ₐCF₂CF₂—;
(vii) —CF₂O(CF₂CF₂O)ₐ(CF₂O)_{b}CF₂—;
(viii) —CF₂O(CF₂CF₂O)ₐCF₂—;
   or a combination thereof;
wherein each a, when present, is independently from 1 to 20,
wherein each b, when present, is independently from 1 to 20;
wherein n is from 1 to 20; and
wherein at least one R¹ is an anchoring functional group engageable with a protective overcoat of a magnetic recording medium, comprising B, Si, a pnictogen, a chalcogen, a halogen, —OR*, —NR*₂, —NR*—CO—R*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, wherein two or more R* may join together to form a ring structure.

In one aspect, the lubricant described above wherein at least one R¹ comprises a hydroxyl moiety (—OH).

In one aspect, the lubricant described above wherein Rc, when present, comprises an ester functional group comprising general formula (XXI), (XXII), or a combination thereof:

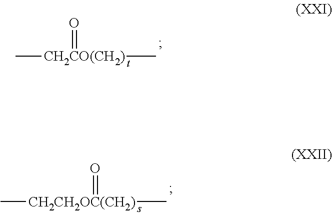

wherein t, when present, is from 1 to 20; and
wherein s, when present, is from 1 to 20.

In one aspect, the lubricant described above wherein Rb¹, and Rb² when present, comprise the formula:
(iv) —CF₂CF₂CF₂O(CF₂CF₂CF₂CF₂O)ₐCF₂CF₂CF₂—;
(v) —CF₂CF₂O(CF₂CF₂CF₂O)ₐCF₂CF₂—;
(vi) —CF₂CF₂O[CF(CF₃)CF₂O]ₐCF₂CF₂—;
(vii) —CF₂O(CF₂CF₂O)ₐ(CF₂O)_{b}CF₂—;
(viii) —CF₂O(CF₂CF₂O)ₐCF₂—;
   or a combination thereof;
wherein each a is, independently from 1 to 20, and
wherein each b, when present, is independently from 1 to 20.

In one aspect, the lubricant described above comprising a weight average molecular weight from about 0.1 to 20 kiloDaltons (kDa).

In one aspect, a magnetic recording medium, comprising: a magnetic recording layer on a substrate; a protective overcoat on the magnetic recording layer; and a lubricant layer comprising the lubricant described above on the protective overcoat.

In one aspect, data storage system, comprising: at least one magnetic head; a magnetic recording medium including the lubricant described above; a drive mechanism for positioning the at least one magnetic head over the magnetic recording medium; and a controller electrically coupled to the at least one magnetic head for controlling operation of the at least one magnetic head.

In one aspect, a data storage system, comprising: a slider comprising at least one magnetic head and an air bearing surface (ABS), wherein a lubricant described above is disposed on the ABS; and the magnetic recording medium including a magnetic recording layer; wherein the slider is configured to write information to the magnetic recording layer using heat assisted magnetic recording (HAMR).

In one aspect, this disclosure provides a lubricant comprising: a plurality of segments according to general formula (I), (II), or (III):

Re¹—Rb¹-Rc-Rb²—Re² (I);

Re¹—Rb¹—Re² (II); or

Re¹—Rb¹—(Rc-Rb²)ₘ-Re² (III);
wherein Rc, when present, is a divalent linking segment that optionally includes a first anchoring functional group;
wherein each Rb¹ and Rb², when present, independently comprises a chain segment comprising at least one of a fluoroalkyl ether moiety, a fluoroalkenyl ether moiety, a perfluoroalkyl ether moiety, a perfluoroalkenyl ether moiety, or a combination thereof;
wherein each of Re¹ and Re² independently comprises a group having a higher rotational energy barrier than that of CH₂ terminating with at least one second anchoring functional group engageable with the protective overcoat of the magnetic recording medium comprising —CH₂OCH₂(CH₂)ₙ(Ra)ₙ₋₁ or —OCH₂(CH₂)ₙ(Ra)ₙ₋₁, Ra is the second anchoring functional group and n=1-10.

Other aspects and advantages of the present disclosure will become apparent from the following detailed description and examples, when considered in conjunction with the drawings.

### BRIEF DESCRIPTION OF THE DRAWINGS

FIG. 1A is a diagram schematically illustrating a data storage device including a slider and a magnetic recording medium in accordance with one aspect of the disclosure.

FIG. 1B is a side schematic view of the slider and magnetic recording medium of FIG. 1A in accordance with one aspect of the disclosure.

FIG. 2 is a side schematic view of a head assisted magnetic recording (HAMR) medium in accordance with one aspect of the disclosure.

FIG. 3A is a schematic drawing showing a lubricant according to the disclosure comprising a single main chain segment and a functional group according to one aspect of the disclosure.

FIG. 3B is a schematic drawing showing a lubricant according to the disclosure comprising a single main chain segment and a multitude of functional groups according to one aspect of the disclosure.

FIG. 3C is a schematic drawing showing a lubricant according to the disclosure comprising two chain segments comprising terminal cyclic functional groups and separated by a linking segment according to one aspect of the disclosure.

FIG. 3D is a schematic drawing showing a lubricant according to the disclosure comprising two chain segments comprising terminal cyclic functional groups and separated by a linking segment comprising cyclic functional groups according to one aspect of the disclosure.

FIG. 3E is a schematic drawing showing a lubricant according to the disclosure comprising two chain segments comprising terminal functional groups and separated by a linking segment according to one aspect of the disclosure.

FIG. 4 is a graph of lubricant loss showing the effect on molecular stiffness from the presence of —OH groups.

FIG. 5A is a graph showing discoloration (absorbance versus wavelength) of a magnetic recording medium with increasing time according to one aspect of the disclosure.

FIG. 5B illustrates schematic drawings of photographs showing the discoloration of magnetic recording media/disks with increasing time in accordance with an aspect of the disclosure.

FIG. 6 is the thermogravimetric (TGA) analysis of an untreated test lubricant of the disclosure compared to a heat treated sample of the test lubricant in accordance with an aspect of the disclosure.

FIG. 7 shows the rearrangement of the end group molecular structure to maintain the large evaporation temperature while avoiding the observed decomposition with heating, in accordance with an aspect of the disclosure.

FIG. 8 shows a typical synthetic pathway to obtain an end group including benzene or anisole in accordance with an aspect of the disclosure.

FIG. 9 is a flowchart of an exemplary process for fabricating a HAMR medium that includes a magnetic recording layer, a capping layer, an overcoat and a lubricant, in accordance with an aspect of the disclosure.

### DETAILED DESCRIPTION

Heat Assisted Magnetic Recording (HAMR) systems operate at substantially higher temperatures than traditional magnetic recording systems. HAMR is an example of magnetic recording within the class of Energy Assisted Magnetic Recording (EAMR) techniques, where conventional magnetic recording is supplemented by other energy used in the system. Other examples of EAMR may include Microwave Assisted Magnetic Recording (MAMR) and applications of electric current into various conductive and/or magnetic structures near the main pole. This disclosure is generally directed to lubricants having high thermal stability that can be used in conjunction with a magnetic recording medium and/or a magnetic data storage system including a HAMR, or more generally EAMR, magnetic recording medium or storage system.

In short, the disclosure pertains to high temperature lubricants, which may be used with media configured for magnetic recording, e.g., for HAMR, having more thermally stable end groups. The lubricant of the disclosure may be formed from a plurality of segments according to general formula (I), (II), or (III):

Re¹—Rb¹-Rc-Rb²—Re² (I);

Re¹—Rb¹—Re² (II); or

Re¹—Rb¹—(Rc-Rb²)ₘ-Re² (III);
where Rc, when present, is a divalent linking segment that optionally includes a first anchoring functional group engageable with a protective overcoat of a magnetic recording medium; where each Rb¹ and Rb², when present, independently comprises a chain segment comprising at least one of a fluoroalkyl ether moiety, a fluoroalkenyl ether moiety, a perfluoroalkyl ether moiety, a perfluoroalkenyl ether moiety, or a combination thereof; where each of Re¹ and Re² independently comprises a group having a higher rotational energy barrier than that of CH₂ terminating with at least one second anchoring functional group engageable with the protective overcoat of the magnetic recording medium comprising CH₂OCH₂(CH₂)ₙ(Ra)ₙ₋₁ or —OCH₂(CH₂)ₙ(Ra)ₙ₋₁, Ra is the second anchoring functional group and n=1-10. Among the anchoring functional groups, the first and second anchoring functional groups each most commonly are a hydroxyl (—OH) moiety.

### Definitions

For purposes herein, and the claims thereto, the new numbering scheme for the Periodic Table Groups is used as described in Chemical and Engineering News, 63(5), pg. 27 (1985). Therefore, a “group 4 metal” is an element from group 4 of the Periodic Table, e.g. Hf, Ti, or Zr.

As used herein, and unless otherwise specified, the term “Cₙ” means hydrocarbon(s) having n carbon atom(s) per molecule, where n is a positive integer. Likewise, a “Cₘ-C_{y}” group or compound refers to a group or compound comprising carbon atoms at a total number thereof in the range from m to y. Thus, a C₁-C₄ alkyl group refers to an alkyl group that includes carbon atoms at a total number thereof in the range of 1 to 4, e.g., 1, 2, 3 and 4.

“Moiety” refers to one or more covalently bonded atoms which form a part of a molecule. The terms “group,” “radical,” “moiety”, and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Preferred hydrocarbyls are C₁-C₅₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl, naphthyl, and the like.

For purposes herein, a heteroatom is any non-carbon atom, selected from groups 13 through 17 of the periodic table of the elements. In one or more aspects, heteroatoms are non-metallic atoms selected from B, Si, pnictogens (N, P, As, Sb, Bi), chalcogen (O, S, Se, Te), and halogens (F, Cl, Br, I).

Unless otherwise indicated, the term “substituted” means that at least one hydrogen atom has been replaced with at least one non-hydrogen atom or a functional group.

For purposes herein, when a segment comprises or includes a particular moiety, it is to be understood that the moiety may be bonded to the respective segment at any substitutable position in which a hydrogen atom may be replaced with a chemical bond between the moiety and the segment.

For purposes herein, a functional group includes one or more of a hydrocarbyl group, a heteroatom, or a heteroatom containing group, such as B, Si, pnictogen, chalcogen, or halogen (such as Br, C₁, F or I), at least one of —OR*, —NR*₂, —NR*—CO—R*, —OR*, *—O—CO—R*, —CO—O—R*, —SeR*, —TeR*, —PR*₂, —PO—(OR*)₂, —O—PO—(OR*)₂, —AsR*₂, —SbR*₂, —SR*, —SO₂—(OR*)₂, —BR*₂, —SiR*₃, —(CH₂)_{q}—SiR*₃, or a combination thereof, wherein q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure, or where at least one heteroatom has been inserted within a hydrocarbyl ring. In an aspect, R* is H such that the functional group may be —OH, —NH₂, —NH—CO—H, —OH, H—O—CO—H, —CO—O—H, —SeH, —TeH, —PH₂, —PO—(OH)₂, —O—PO—(OH)₂, —AsH₂, —SbH₂, —SH, —SO₂—(OH)₂, —BH₂, —SiH₃, —(CH₂)_{q}—SiH₃, or a combination thereof.

In one or more aspects, functional groups may include: a saturated C₁-C₅₀ radical, an unsaturated C₁-C₅₀ radical, an alicyclic C₃-C₅₀ radical, a heterocyclic C₃-C₅₀ radical, an aromatic C₅-C₅₀ radical, a heteroaromatic C₅-C₅₀ radical, a cyclotriphosphazine radical, a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, pnictogen, chalcogen, halogen, saturated, unsaturated, aromatic, polycyclic aromatic, heteroaromatic, alicyclic, and/or heterocyclic C₄-C₅₀ radical. Anchoring functional groups can also be least one of —OH, —NH₂, —NH—CO—H, —O—CO—H, —CO—O—H, —SeH, —TeH, —PH₂, —PO—(OH)₂, —O—PO—(OH)₂, —N=P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof.

For purposes herein, a cyclic functional group is a monovalent alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof. Unless otherwise indicated, the cyclic functional group may be further substituted with another cyclic functional group and/or with one or more functional groups comprising one or more of a saturated C₁-C₅₀ radical, an unsaturated C₁-C₅₀ radical, an alicyclic C₃-C₅₀ radical, a heterocyclic C₃-C₅₀ radical, an aromatic C₅-C₅₀ radical, a heteroaromatic C₅-C₅₀ radical, a cyclotriphosphazine radical, a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, or a saturated, unsaturated, aromatic, polycyclic aromatic, heteroaromatic, alicyclic, and/or heterocyclic C₁-C₅₀ radical.

For purposes as described herein, an anchoring functional group which is selected for being attachable to and/or engageable with a protective overcoat of a magnetic recording medium refers to a functional group having increased affinity for the protective overcoat of the magnetic recording medium relative to the affinity of the a fluoroalkenyl ether moiety, a perfluoroalkyl ether moiety, a perfluoroalkenyl ether moieties, to that same surface. Increased affinity may include Van der Waals forces, weak London Dispersion forces, dipole-dipole forces, polar interactions, polarizability/hydrogen bonding interactions, and/or the like, and/or may include the formation of one or more types of bonds, backbonding, and/or dative bonds with the protective overcoat of a recording medium. In one or more aspects, a functional group which is attachable to and/or engageable with a protective overcoat of a magnetic recording medium refers to one or more functional groups having increased affinity for the carbon overcoat (COC) layer of the recording medium, relative to the affinity of a fluoroalkenyl ether moiety, a perfluoroalkyl ether moiety, a perfluoroalkenyl ether moieties to that same surface. In some aspects, functional groups attachable to and/or engageable with a protective overcoat of a magnetic recording medium include radicals comprising one or more hydroxyl moieties (—OH), or consisting of a hydroxyl moiety (—OH).

A heterocyclic ring, also referred to herein as a heterocyclic radical, is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring is a heterocyclic ring where a hydrogen of one of the ring atoms is substituted, e.g., replaced with a hydrocarbyl, or a heteroatom containing group.

A “compound” refers to a substance formed by the chemical bonding of a plurality chemical elements. A “derivative” refers to a compound in which one or more of the atoms or functional groups of a precursor compound have been replaced by another atom or functional group, generally by means of a chemical reaction having one or more steps.

Fluorinated alkyl ethers including fluoroalkyl ethers, fluoroalkenyl ethers, perfluoroalkyl ethers, perfluoroalkenyl ethers, or combinations thereof, refer to branched or linear chain of C₁ to C₂₀ alkyl ethers in which one or more hydrogen atoms are substituted with fluorine. In one aspect, all or a majority of alkyl hydrogen atoms are substituted with fluorine.

For any particular compound disclosed herein, any general or specific structure presented also encompasses all conformational isomers, regio-isomers, and stereoisomers that may arise from a particular set of substituents, unless stated otherwise. Similarly, unless stated otherwise, the general or specific structure also encompasses all enantiomers, diastereomers, and other optical isomers whether in enantiomeric or racemic forms, as well as mixtures of stereoisomers, as would be recognized by a skilled artisan.

As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

As used herein, a moiety which is chemically identical to another moiety is defined as being identical in overall composition exclusive of isotopic abundance and/or distribution, and/or exclusive of stereochemical arrangement such as optical isomers, confirmational isomers, spatial isomers, and/or the like.

### HAMR System for Employing Lubricant

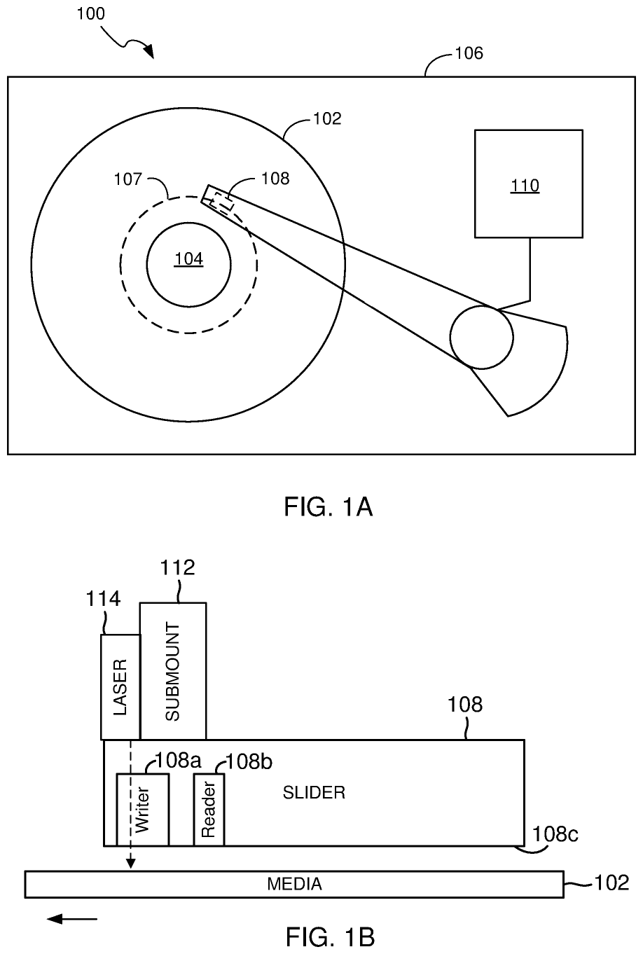

FIG. 1A is a top schematic view of a data storage device 100 (e.g., disk drive or magnetic recording device) configured for heat assisted magnetic recording (HAMR) including a slider 108 and a magnetic recording medium 102 having a lubricant according to one or more aspects of the disclosure. The laser (not visible in FIG. 1A, but see 114 in FIG. 1B) is positioned with a head/slider 108. Disk drive 100 may include one or more disks/media 102 to store data. Disk/media 102 resides on a spindle assembly 104 that is mounted to a drive housing. Data may be stored along tracks in the magnetic recording layer of disk 102. The reading and writing of data is accomplished with the head 108 (slider) that may have both read and write elements (108a and 108b). The write element 108a is used to alter the properties of the magnetic recording layer of disk 102 and thereby write information thereto. In one aspect, head 108 may have magneto-resistive (MR), giant magneto-resistive (GMR), or tunnel magneto-resistive (TMR) elements. In an alternative aspect, head 108 may be another type of head, for example, a Hall effect head. In operation, a spindle motor (not shown) rotates the spindle assembly 104, and thereby rotates the disk 102 to position the head 108 at a particular location along a desired disk track 107. The position of the head 108 relative to the disk 102 may be controlled by the control circuitry 110 (e.g., a microcontroller). It is noted that while an example HAMR system is shown, the various embodiments described may be used in other EAMR or non-EAMR magnetic data recording systems, including perpendicular magnetic recording (PMR) disk drives or magnetic tape drives.

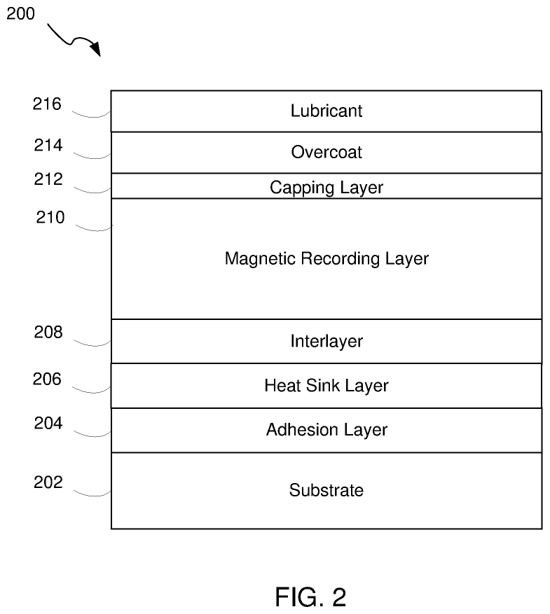

FIG. 1B is a side schematic view of the slider 108 and magnetic recording medium 102 of FIG. 1A. The magnetic recording medium 102 includes a lubricant layer (see FIG. 2) in accordance with one or more aspects of the disclosure. The slider 108 may include a sub-mount 112 attached to a top surface of the slider 108. The laser 114 may be attached to the sub-mount 112, and possibly to the slider 108. The slider 108 includes a write element (e.g., writer) 108a and a read element (e.g., reader) 108b positioned along an air bearing surface (ABS) 108c of the slider for writing information to, and reading information from, respectively, the medium 102. In other aspects, the slider may also include a layer of the lubricant (not shown).

In operation, the laser 114 is configured to generate and direct light energy to a waveguide (possibly along the dashed line) in the slider which directs the light to a near field transducer (NFT) near the air bearing surface (e.g., bottom surface) 108c of the slider 108. Upon receiving the light from the laser 114 via the waveguide, the NFT generates localized heat energy that heats a portion of the medium 102 near the write element 108a and the read element 108b. The anticipated recording temperature is in the range of about 350° C. to 400° C. In the aspect illustrated in FIG. 1B, the laser directed light is disposed between the writer 108a and a trailing edge of the slider. In other aspects, the laser directed light may instead be positioned between the writer 108a and the reader 108b. FIGS. 1A and 1B illustrate a specific aspect of a HAMR system. In other aspects, the magnetic recording medium 102 with the lubricant layer according to aspects of the disclosure can be used in other suitable HAMR systems (e.g., with other sliders configured for HAMR).

FIG. 2 is a side schematic view of a magnetic recording medium 200 having a lubricant layer according to one or more aspects of the disclosure. In one aspect, the magnetic recording medium 200 may be used in a HAMR system (e.g., disk drive 100). The magnetic recording medium 200 has a stacked structure with a substrate 202 at a bottom/base layer, an adhesion layer 204 on the substrate 202, a heat sink layer 206 on the adhesion layer 204, an interlayer 208 on the heat sink layer 206, a magnetic recording layer (MRL) 210 on the interlayer 208, a capping layer 212 on the MRL 210, an overcoat layer 214 on the capping layer 212, and a lubricant layer 216 on the overcoat layer 214. In one aspect, the magnetic recording medium 200 may have a soft magnetic underlayer (SUL) between the adhesion layer 204 and the heat sink layer 206. In one aspect, the magnetic recording medium 200 may have a thermal resistance layer (TRL) between the interlayer 208 and the heat sink layer 206. In one aspect, for disk drive applications, the substrate 202 can be made of one or more materials such as an Al alloy, NiP plated Al, glass, glass ceramic, and/or combinations thereof. In one aspect for magnetic tape recording applications, the substrate 202 can include a flexible material, such a film made of one of various types of resins, polyesters, polyolefins, polyamides, and the like, or combinations thereof. The substrate may include non-magnetic materials, and may be laminated. In some aspects, the magnetic recording medium 200 may have some or all of the layers illustrated in FIG. 2 and/or additional layer(s) in various stacking orders. It should also be noted that each layer shown in FIG. 2 may include one or more sub-layers. For example, the magnetic recording layer may comprise a multiple layers in certain embodiments. Also, some of the layers may be etched before the next layer is applied.

Lubricants according to aspects disclosed herein may function as boundary lubricants which may be used in various mechanical devices, including on the magnetic media of hard disk drives or tape drives and in conjunction with other microelectronic mechanical systems. Boundary lubricants may form a lubricant layer when one or more functional groups of the lubricant attach or otherwise engage with the surface being lubricated. For instance, one or more boundary lubricants may form the lubricant layer 216 on magnetic recording medium 200 (e.g., a disk that includes a magnetic recording layer 210) that moves relative to other parts in the magnetic storage device. This lubricant layer 216 may help to protect the magnetic recording medium from friction, wear, contaminations, smearing, and/or damages caused by interactions between the magnetic recording medium and other parts in the storage device (e.g., interactions between a slider and the magnetic recording medium). In other words, this boundary layer may help limit solid-to-solid contact.

### Lubricant Characteristics

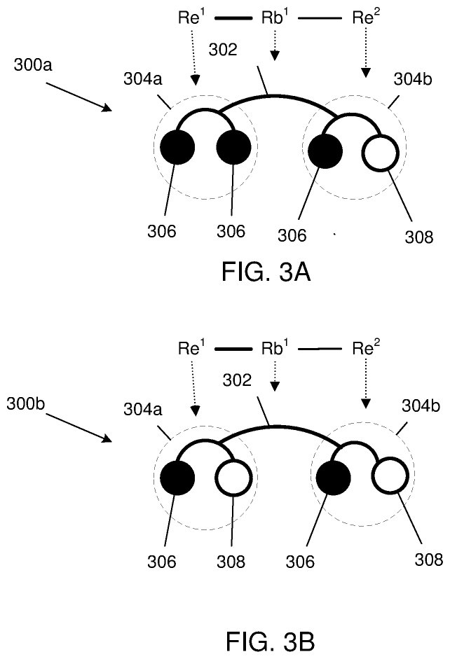

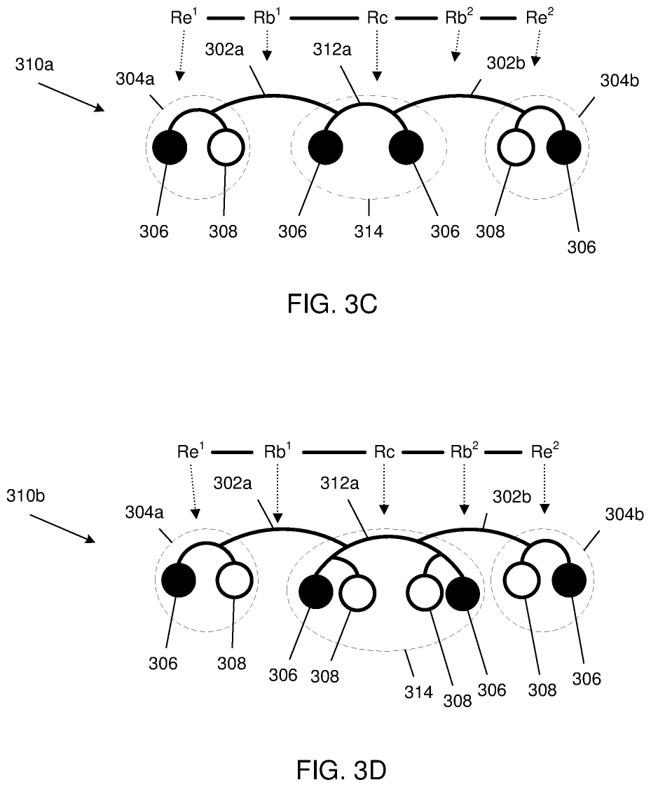

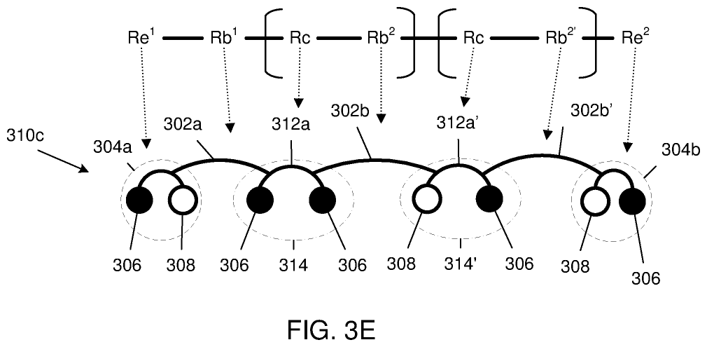

FIGS. 3A-3D illustrate boundary lubricants according to aspects of the disclosure. In one aspect as shown in FIG. 3A, the boundary lubricant generally referred to as 300a comprises or may have general formula (II):

Re¹—Rb¹—Re² (II);

wherein Rb¹ (302) comprises or is a chain segment including a fluoroalkyl, fluoroalkenyl, perfluoroalkyl, or perfluoroalkyl ether moiety bonded on either side to an end segment 304a and 304b. In the aspect shown in FIG. 3A, the chain segment Rb¹ (302) may be also be referred to as a main chain segment. Each of Re¹ (304a) and Re² (304b) are end segments which independently includes an anchoring functional group 306 selected for being attachable to and/or engageable with a protective overcoat of a magnetic recording medium (see FIG. 2). In the aspect shown, one or more of the end segments Re¹ (304a) and Re² (304b) includes a group that has a higher rotational energy barrier than CH₂, which can be for example benzene, anisole, other aromatic groups, (CF₂)ₙ where n=1-10, etc.

As shown in FIG. 3B, in one aspect indicated as 300b, each end group segment may include a cyclic or aromatic functional group 308.

In one aspect as shown in FIG. 3C, the boundary lubricant generally referred to as 310a may comprise or has general formula (I):

Re¹—Rb¹-Rc-Rb²—Re² (I);

where the end segments Re¹ (304a) and Re² (304b) are as described above; in this aspect there are two chain segments Rb¹ (302a) and Rb² (302b), which may also be referred to herein as sidechain segments, both of which independently comprises a fluoroalkyl, fluoroalkenyl, perfluoroalkyl, or perfluoroalkyl ether moiety.

As is indicated in FIG. 3C, whether referred to as a chain segment, a main chain segment (when only one is present), or a sidechain segment (when two or more are present), each of the segments are similar to one another in that each segment comprises a fluoroalkyl, fluoroalkenyl, perfluoroalkyl, or perfluoroalkyl ether moiety.

In the aspect shown in FIG. 3C, the lubricant may further include a divalent linking segment Rc (312), generally indicated as 314, also referred to herein as a center segment, which is disposed between either end of the sidechain segments 302a and 302b, and which includes at least one anchoring functional group (306) as defined herein.

As shown in FIG. 3D, in one aspect generally indicated as 310b, the divalent linking segment Rc (312) may further include at least one cyclic functional group 308 as defined herein.

In one aspect as shown in FIG. 3E, the boundary lubricant generally referred to as 310c may comprise or has general formula (III):

Re¹—Rb¹—(Rc-Rb²)ₘ-Re² (III);

wherein m=2, comprising two units of the divalent linking segments; a first unit comprising Rc (312a) also generally indicated as (314), attached to a chain segment Rb² (302b), which is attached to a second unit comprising Rc (312a′) also generally indicated as (314′) and a second chain segment Rb²′ (302b′). The end segments Re¹ (304a) and Re² (304b) are attached to either end of the molecule. The composition of each of the segments may be independent of one another. The composition of each of the segments is according to the description of general formula (I) herein.

In one aspect, each anchoring functional group may independently comprises a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, or a saturated, unsaturated, aromatic, polycyclic aromatic, heteroaromatic, alicyclic, and/or heterocyclic C₁-C₅₀ radical, and two or more R* may join together to form a ring structure. When R* is H, the anchoring functional group can be OH, —NH₂, —NH—CO—H, —OH, —O—CO—H, —CO—O—H, —SeH, —TeH, —PH₂, —PO—(OH)₂, —O—PO—(OH)₂, —N=P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof.

In one aspect, each cyclic functional group may further comprise, e.g., may be further substituted with a functional group comprising at least one of a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, a saturated, unsaturated, aromatic, polycyclic aromatic, heteroaromatic, alicyclic, and/or heterocyclic C₁-C₅₀ radical, and two or more R* may join together to form a ring structure.

In one aspect, one or more anchoring functional group may include, or is, a hydroxyl (—OH) moiety. In one aspect, each anchoring functional group includes or is a hydroxyl (—OH) moiety. In some aspects, one or more cyclic functional groups may comprise a hydroxyl (—OH) moiety. In some aspects, each cyclic functional group comprises a hydroxyl (—OH) moiety.

### Lubricant Compositions

In one aspect, one such lubricant comprises or is according to general formula (I), (II) or (III):

Re¹—Rb¹-Rc-Rb²—Re² (I);

Re¹—Rb¹—Re² (II); or

Re¹—Rb¹—(Rc-Rb²)ₘ-Re² (III);

where Rc, when present, is a divalent linking segment optionally including a first anchoring functional group engageable with a protective overcoat of a magnetic recording medium. Each Rb¹ and Rb², when present, independently is a chain segment having at least one of a fluoroalkyl ether moiety, a fluoroalkenyl ether moiety, a perfluoroalkyl ether moiety, a perfluoroalkenyl ether moiety, or a combination thereof. Each of Re¹ and Re² independently comprises a group having a higher rotational energy barrier than CH₂ terminating with —CH₂OCH₂(CH₂)ₙ(Ra)ₙ₋₁ or —OCH₂(CH₂)ₙ(Ra)ₙ₋₁ with Ra being a second anchoring functional group and n=1-10. The lubricant of the disclosure can also be expressed as formula (Ia), (IIa) or (IIIa):

Rt-Re¹—Rb¹-Rc-Rb²—Re²-Rt (Ia);

Rt-Re¹—Rb¹—Re²-Rt (IIa); or

Rt-Re¹—Rb¹—(Rc-Rb²)ₘ-Re²-Rt (IIIa);

with Rc, Rb¹ and Rb² as defined above, Re¹ and Re² independently comprises a group having a higher rotational energy barrier than CH₂ and each Rt independently comprises a group that is —CH₂OCH₂(CH₂)ₙ(Ra)ₙ₋₁ or —OCH₂(CH₂)ₙ(Ra)ₙ₋₁ with Ra being a second anchoring functional group and n=1-10. The group having a higher rotational energy barrier than CH₂ may be an aromatic group such as benzene or anisole or, alternately, a non-aromatic group having more steric hindrance than CH₂ such as CF₂.

The presence of groups having a higher rotational energy barrier than CH₂ which, for example, can be an aromatic moiety such as anisole, helps to increase the evaporation temperature of the lubricant through increasing the stiffness of the molecule rather than increasing the interaction energy of the lubricant with the disk. However, an anisole containing end group is associated with thermally activated reactions. Such an anisole containing end group can be seen in general formula (IV):

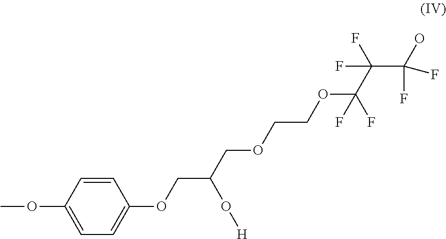

Rearrangement of the end group may inhibit the thermally activated reactions while maintaining high evaporation temperatures due to increased molecular stiffness. Examples of the end groups of the disclosure are shown in formulas (V) and (VI):

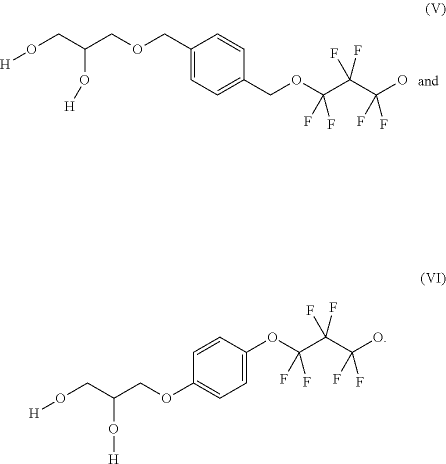

In the end groups of the disclosure the anchoring groups (such as —OH) are moved farther away from the benzene ring or the anisole to the gamma (γ), delta (δ) or epsilon (ε) position. This rearrangement of the anchoring end group inhibits thermally activated reactions while maintaining a high evaporation temperature. Since the anisole end-group is no longer substituting a —OH group, the lubricant molecule also has increased interaction energy in addition to increased stiffness; combined these two effects will further increase the evaporation temperature relative to IV.

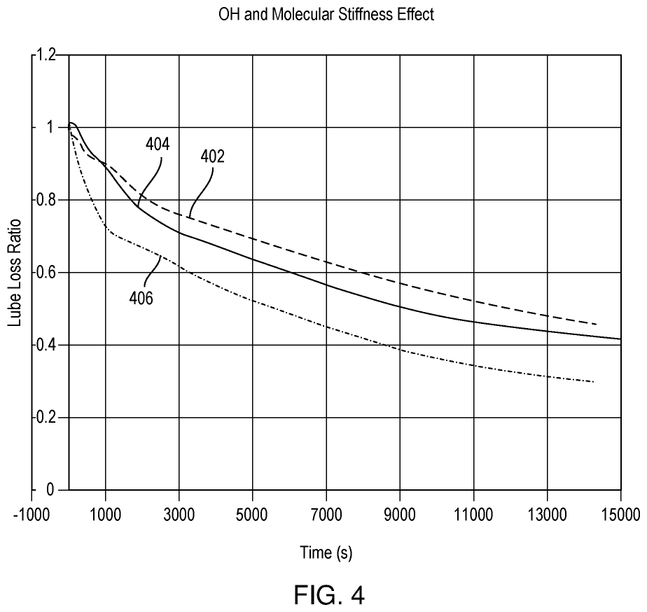

This effect can be seen in FIG. 4 which compares test lube 402, which has an additional OH end group relative to test lube 404, but identical molecular stiffness. Test lube 406 has the same number of OH groups as test lube 402, but has a lower molecular stiffness. Thus, one expects by combining the increased number of OH groups with the added increases in molecular stiffness by rearranging the benzene, it will further decrease the evaporation of the lubricant.

The end group is not restricted to a dihydroxy propyl configuration. The anchoring groups can be farther away from the group having a higher rotational energy barrier than CH₂ (which can be benzene or anisole), as is shown in formulas (VII) and (VIII):

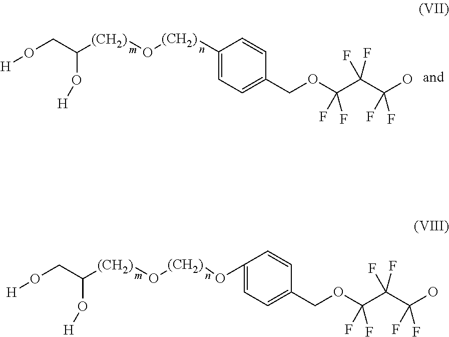

where n is 0 to 10 and m is 1 to 10. Also, (CH₂)ₙ and (CH₂)ₘ are not restricted to hydrocarbon but also may be fluorocarbons such as (CF₂)ₙ and (CF₂)ₘ.

In the disclosure, the substitution of the aromatic group such as benzene is not restricted to para substitution. The substitution can also be ortho or meta, as can be seen in formulas (IX) to (XIV):

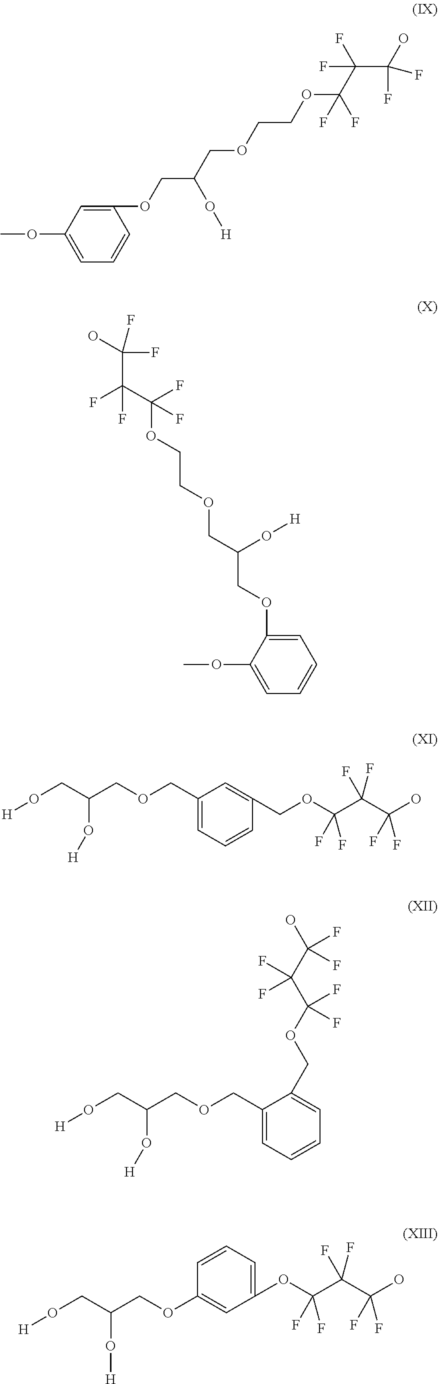 [SMILES: COc1cccc(OCC(O)COCCOC(F)(F)C(F)(F)C(O)(F)F)c1 ; COc1ccccc1OCC(O)COCCOC(F)(F)C(F)(F)C(O)(F)F ; OCC(O)COCc1cccc(COC(F)(F)C(F)(F)C(O)(F)F)c1 ; OCC(O)COCc1ccccc1COC(F)(F)C(F)(F)C(O)(F)F ; OCC(O)COc1cccc(OC(F)(F)C(F)(F)C(O)(F)F)c1]

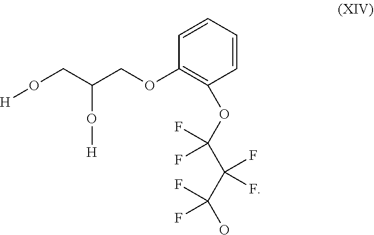 [SMILES: OCC(O)COc1ccccc1OC(F)(F)C(F)(F)C(O)(F)F]

The aromatic moiety, when present, is not restricted to benzene. Other aromatic groups can be present, for example, naphthalene, as shown in formulas (XV) and (XVI):

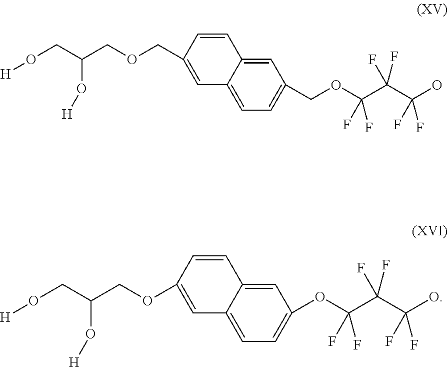

Other aromatic groups can also be used, for example, anthracene, phenanthrene, benzanthracene, dibenzanthracene, pyrene, benzopyrene, etc.

Examples of the complete lubricant molecule are shown in formulas (XVII) and (XVIII):

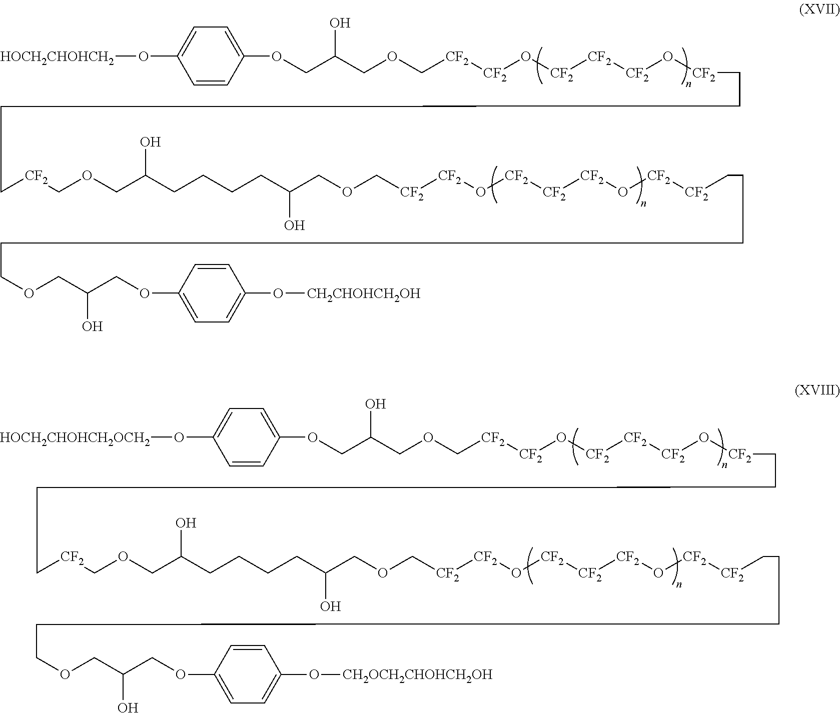

where n=1-10.

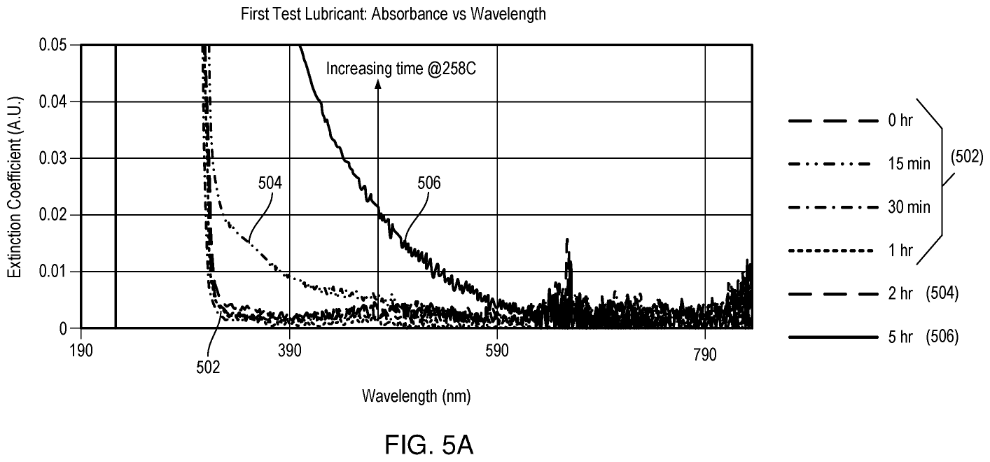

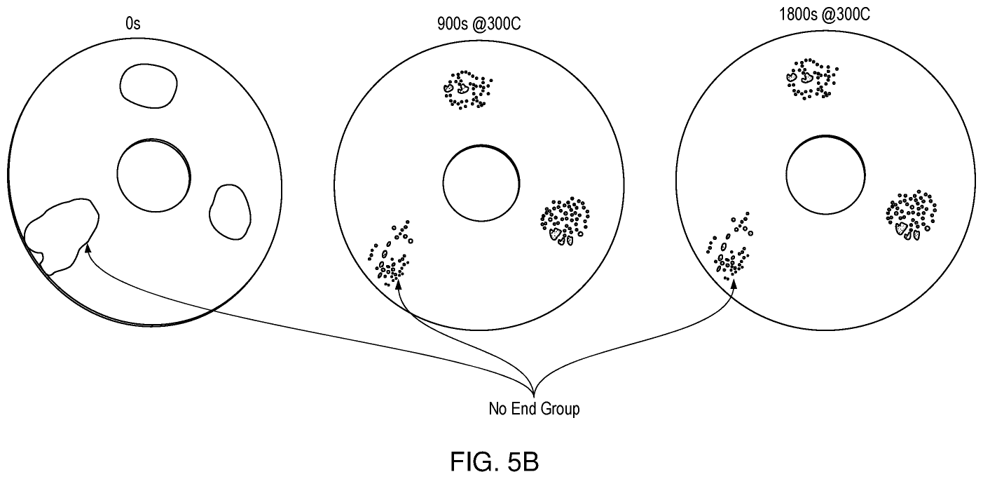

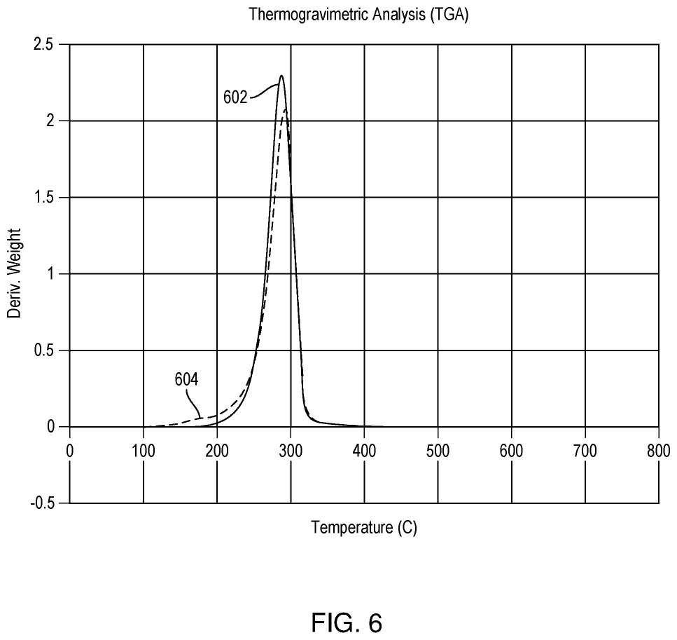

The effect of anisole/benzene position in the end group is demonstrated in the decomposition experiment shown in FIG. 5A for a first test lubricant, which is non-fluorinated. As shown in FIG. 5A, heating lubricants that utilize an anisole-containing end group such as shown in fluorinated formula (IV) results in a change in color. From 0 hours to 1 hour the extinction coefficient 502 of the test lubricant stays stable. At 2 hours there is an increase in the extinction coefficient 504 from the baseline starting at 590 nm or less. At 5 hours the extinction coefficient 506 dramatically rises as the wavelength drops below 590 nm. After baking the resulting material took a long time (and sonication) to dissolve compared to an unbaked sample. This suggests that the anisole group may catalyze a type of polymerization reaction which increases the amount of conjugation or some other type of product within the polymer, which is correlated with visible wavelength absorbance. This decomposition product has a much lower evaporation temperature than the neat lube as can be seen in FIG. 6. The decomposition product evaporates at 185° C. compared to the neat lube at 288° C.

FIG. 5B shows photographs of the discoloration or yellowing of the first test lubricant containing the anisole end group. Little or no discoloration is observed at 0 seconds. After 900 seconds at 300° C., discoloration is observed, with the discoloration deepening at 1800 seconds. This suggests that the rate of decomposition is much greater than the rate of evaporation of the decomposition product for the anisole containing end-group. No noticeable discoloration is observed for the test lubricant without the anisole end-group.

FIG. 6 is the thermogravimetric analysis (TGA) graph of the lubricant of the disclosure untreated (i.e., taken neat) 602 and when heat challenged 604 (e.g., after 5 hours at 250° C. in air). The decomposition product comes off at the shoulder at 185° C. The neat lubricant 602 has a slightly lower peak at about 290° C. while the challenged lubricant 604 has a slightly higher peak at about 300° C., which indicates a performance similar to the neat material.

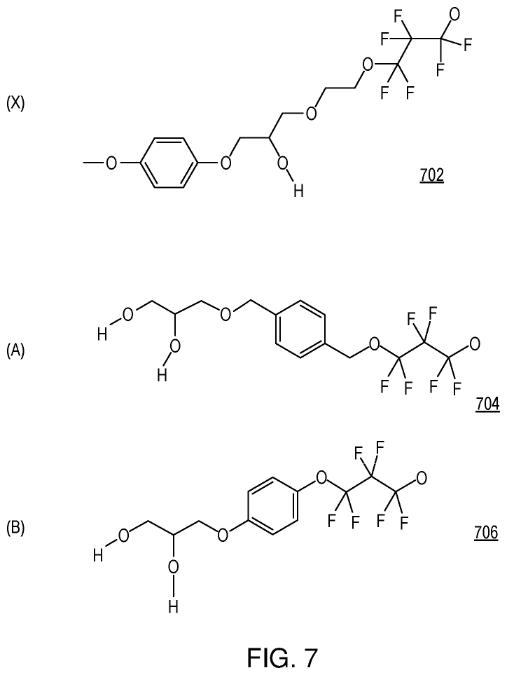

FIG. 7 shows the rearrangement of the end group molecular structure that is believed to both avoid the decomposition and also increase the evaporation temperature due to the additional —OH interaction. Structure X (702), at top, has the anchoring group, in this example —OH, between the anisole group and the fluorocarbon chain leading to the center of the molecule. Structures A (704) and B (706) have the anchoring groups at the terminal end of the molecule, with the —OH groups being delta (δ) and epsilon (ε) to the benzene ring for structure A, and the —OH groups being gamma (γ) and delta (δ) to the benzene ring for structure B. Structures A and B have more heat resistance than structure X, which arises from the anchoring groups being farther away from the group having the rotational energy barrier higher than CH₂, i.e., anisole, and also having an additional —OH functionality.

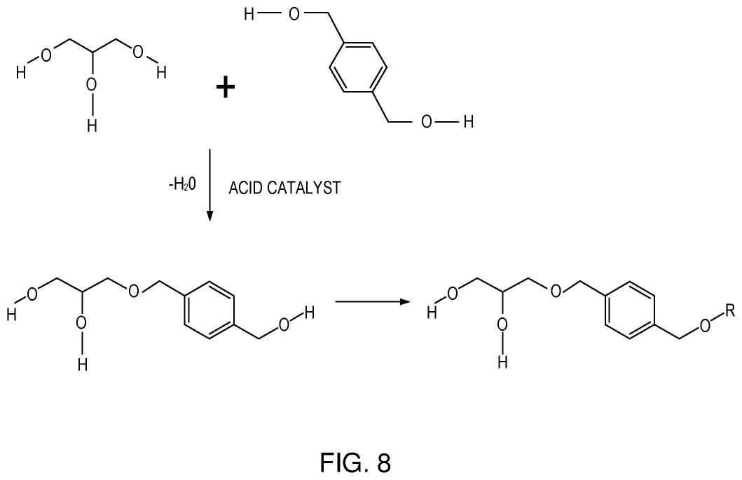

FIG. 8 shows a typical synthetic pathway to obtain an end group including benzene or anisole in accordance with an embodiment of the disclosure. As can be seen, 1,2,3-hydroxy propane reacts with 1,4-dihydroxy benzene (hydroquinone) in an acid catalyst to achieve an end group of the disclosure through a dehydration reaction. The yield will be about 33% or greater. The product is then subjected to further reactions to obtain the lubricant structure of the disclosure. The starting material is not restricted to hydroquinone, and the material can be based on the meta 1,3-dihydroxy benzene (resorcinol) or the ortho 1,2-dihydroxy benzene (catechol).

The multi-dentate structure of the lubricant provides improved levels of head wear, lube pickup, and other properties including improved mechanical integration robustness. The presence of the cyclic functional groups increases thermal stability and reduces the contamination vulnerability when compared with lubricants known in the art.

### Functional Groups Having Higher Rotational Energy Barrier

Applicants have discovered that the presence of functional groups having a higher rotational energy barrier than CH₂ provide a multifaceted benefit for applications involving higher operational temperatures (e.g., such as HAMR media applications) when these functional groups are present in the end segments and/or the center or linking segment pendant to the chain segments according to aspects disclosed herein. It has been discovered that the presence of functional groups having a higher rotational energy barrier than CH₂ reduce the contamination present on the magnetic recording medium. While not wishing to be bound by theory, it is hypothesized that the cyclic functional groups act as traps for the silane and hydrocarbon contaminants, which may include free-radical traps, which sequester the contaminants and thus, reduce or prevent the contaminants from occupying portions of the magnetic recording medium.

In aspects of the disclosure, functional groups having a higher rotational energy barrier than CH₂ may independently comprise an alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof.

In one aspect, functional groups having a higher rotational energy barrier than CH₂ may include substituted or unsubstituted analogs of borirene, cyclopropenone, furan, pyrrole, imidazole, thiophene, phosphole, pyrazole, oxazole, isoxazole, thiazole, triazole, tetrazole, pentazole, benzene, pyridine, pyrazine, pyrimidine, pyridazine, triazine, tetrazine, pentazine, hexazine, borepin, tropone, azonine, cyclooctadecanonaene, diazapentalene, thienothiophene, trithiapentalene, benzofuran, isobenzofuran, indole, isoindole, benzothiophene, benzo(c)thiophene, benzophosphole, benzimidazole, purine, indazole, benzoxazole, benzisoxazole, benzothiazole, 5-aza-7-deazapurine, naphthalene, quinoline, isoquinoline, quinoxaline, quinazoline, cinnoline, phthalazine, azulene, combinations thereof, and/or the like.

### Divalent Linking Segment (Rc)

In one aspect, a lubricant may have general formulas general formulas (II) or (III):

Re¹—Rb¹-Rc-Rb²—Re² (II); or

Re¹—Rb¹—(Rc-Rb²)ₘ-Re² (III);
wherein m is from 1 to 20; the divalent linking or center segment Rc optionally further includes one or more first anchoring functional groups, and/or one or more cyclic functional groups.

In one aspect, Rc includes or has general formula (IXX):

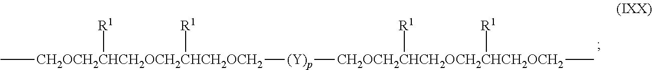

wherein each Y independently comprises:
(i) —CH₂—;
(ii) —CF₂—;
(iii) —CHF—;
(iv) —CF₂CF₂CF₂O(CF₂CF₂CF₂CF₂O)ₐCF₂CF₂CF₂—;
(v) —CF₂CF₂O(CF₂CF₂CF₂O)ₐCF₂CF₂—;
(vi) —CF₂CF₂O[CF(CF₃)CF₂O]ₐCF₂CF₂—;
(vii) —CF₂O(CF₂CF₂O)ₐ(CF₂O)_{b}CF₂—;
(viii) —CF₂O(CF₂CF₂O)ₐCF₂—;
or a combination thereof;
wherein each a is, independently from 1 to 20,
wherein each b, when present, is independently from 1 to 20;
wherein p is from 1 to 20; and
wherein at least one R¹ is an anchoring functional group engageable with a protective overcoat of a magnetic recording medium, formed from B, Si, a pnictogen, a chalcogen, a halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, a heterocyclic C₂-C₅₀ radical, and wherein two or more R* may join together to form a ring structure.

In a related aspect, at least one R¹ present on the linking segment Rc may optionally be a cyclic functional group including an alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof. In one aspect, at least one R¹ present on the linking segment Re may be a hydroxyl moiety (—OH). In another aspect, each R¹ present on the linking segment Re may comprise a hydroxyl moiety, e.g., is a hydroxyl moiety or is substituted with a hydroxyl moiety. In another aspect, each R¹ present on the linking segment Rc is a hydroxyl moiety.

In an aspect, Rc includes or is of general formula (XX):

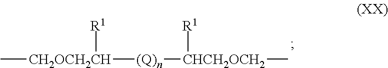

wherein each Q independently comprises:
(i) —CH₂—;
(ii) —CF₂—;
(iii) —CHF—;
(iv) —CF₂CF₂CF₂O(CF₂CF₂CF₂CF₂O)ₐCF₂CF₂CF₂—;
(v) —CF₂CF₂O(CF₂CF₂CF₂O)ₐCF₂CF₂—;
(vi) —CF₂CF₂O[CF(CF₃)CF₂O]ₐCF₂CF₂—;
(vii) —CF₂O(CF₂CF₂O)ₐ(CF₂O)_{b}CF₂—;
(viii) —CF₂O(CF₂CF₂O)ₐCF₂—;
or a combination thereof;
wherein each a is, independently from 1 to 20, or from 1 to 10, or from 1 to 5;
wherein each b, when present, is independently from 1 to 20 or from 1 to 10, or from 1 to 5; wherein n is from 1 to 20 or from 1 to 10, or from 1 to 5; and
wherein at least one R¹, when present, is an anchoring functional group engageable with a protective overcoat of a magnetic recording medium, comprising B, Si, a pnictogen, a chalcogen, a halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, a heterocyclic C₂-C₅₀ radical, wherein two or more R* may join together to form a ring structure.

In a related aspect, at least one R¹, when optionally present on the linking segment Rc, may be a cyclic functional group including an alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof. In one aspect, at least one R¹ present on the linking segment Re may be a hydroxyl moiety (—OH). In another aspect, each R¹, if present on the linking segment Rc, comprises a hydroxyl moiety, e.g., is a hydroxyl moiety or is substituted with a hydroxyl moiety. In another aspect, each R¹ present on the linking segment Rc is a hydroxyl moiety.

In one aspect Re may be an ester functional group according to general formula (XXI), (XXII), or a combination thereof:

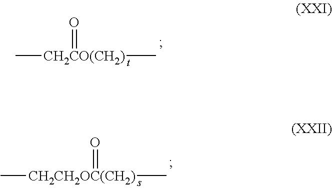

where t, when present, is from 1 to 20, or from 1 to 10, or from 1 to 5; and wherein s, when present, is from 1 to 20, or from 1 to 10, or from 1 to 5.

### Main Chain—Side Chain Segment (Rb)

In one aspect, where a lubricant comprises general formula (II):

Re¹—Rb¹—Re² (II);
and/or in an aspect where a lubricant comprises general formulas (I) or (III):

Re¹—Rb¹-Rc-Rb²—Re² (I); or

Re¹—Rb¹—(Rc-Rb²)ₘ-Re² (III);
wherein m is from 1 to 20; the main chain segment Rb¹ and/or the side chain segments Rb¹ and Rb² include a fluoroalkyl, fluoroalkenyl, perfluoroalkyl, or perfluoroalkyl ether moiety. In one aspect, each chain segment present in the lubricant may comprise or has the formula:
(iv) —CF₂CF₂CF₂O(CF₂CF₂CF₂CF₂O)ₐCF₂CF₂CF₂—;
(v) —CF₂CF₂O(CF₂CF₂CF₂O)ₐCF₂CF₂—;
(vi) —CF₂CF₂O[CF(CF₃)CF₂O]ₐCF₂CF₂—;
(vii) —CF₂O(CF₂CF₂O)ₐ(CF₂O)_{b}CF₂—;
(viii) —CF₂O(CF₂CF₂O)ₐCF₂—;
or a combination thereof, wherein each a is, independently from 1 to 100, or from 1 to 20, or from 1 to 10, or from 1 to 5, and wherein each b, when present, is independently from 1 to 100, or from 1 to 20, or from 1 to 10, or from 1 to 5.

In one or more aspects, the lubricants are stable above about 250° C., or above about 300° C., or above about 325° C., or above about 350° C., or above about 375° C., and less than or equal to about 450° C., or 425° C. when determined in air, nitrogen, helium, or 90 vol % helium 10 vol % oxygen.

In one or more aspects, the lubricant has a weight average molecular weight of greater than or equal to about 0.5 kiloDalton (kDa), or from about 1 to about 20 kDa, or from about 2 to about 10 kDa, or from about 3 to about 7 kDa, or from about 1 to about 5 kDa, or 2 to about 4 kDa.

In one or more aspects, the lubricant has a weight average molecular weight of greater than or equal to about 500 grams per mole (g/mol), or from about 1,000 to about 20,000 g/mol, or from about 2,000 to about 10,000 g/mol, or from about 3,000 to about 7,000 g/mol, or from about 1,000 to about 5,000 g/mol, or 2,000 to about 4,000 g/mol.

In one or more aspects, the lubricants are essentially pure compounds, having a polydispersity, defined as the number average molecular weight Mn divided by the weight average molecular weight Mw (Mn/Mw) from about 1 to 2, or from about 1 to about 1.5, or from about 1 to about 1.1, or from about 1 to about 1.05.

Returning to FIG. 2, in one or more aspects, the magnetic recording medium 200 has a stacked structure which includes a lubricant layer 216 according to the disclosure on the overcoat layer 214.

In one or more aspects, the average thickness of the lubricant layer of the magnetic recording medium is less than about 10 nanometers (nm), or less than about 5 nm, or less than or equal to about 1 nm. In some aspects, the lubricant of the magnetic recording medium has an average thickness from about 0.1 nm to about 10 nm, or from about 0.1 nm to about 1 nm.

In one or more aspects of the magnetic recording medium, the lubricant may have a bonding percentage of at least about 30%, or at least about 50%, or at least about 70%, or at least about 80%, or at least about 90%, and less than or equal to about 99%, or less than or equal to about 95%, corresponding to a post-stripping bonding level of the lubricant to the total area of an upper surface of the protective overcoat.

In one aspect, a magnetic data storage system may include a magnetic head; a magnetic recording medium according to any one or a combination of aspects disclosed herein including a lubricant according to one or more aspects disclosed herein, a drive mechanism for moving the magnetic head over the magnetic recording medium; and a controller electrically coupled to the magnetic head for controlling operation of the magnetic head.

### Media Fabrication

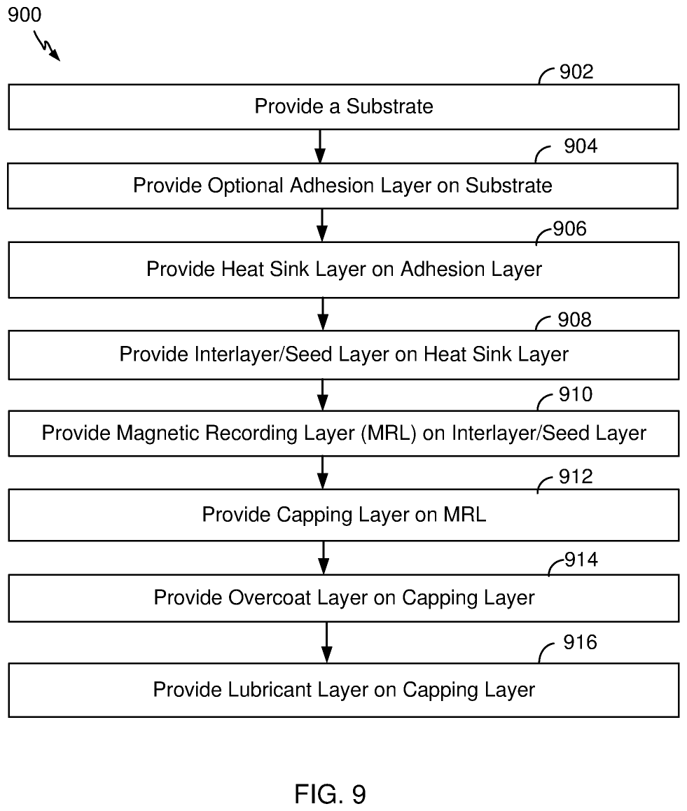

FIG. 9 is a flowchart of an exemplary process 900 for fabricating a HAMR medium that includes a lubricant in accordance with an aspect of the disclosure. In one aspect, the process 900 can be used to fabricate the HAMR media described above, including medium 200 shown in FIG. 2.

At block 902, the process provides a substrate (e.g., substrate 202). At block 904, the process provides an optional adhesion layer (e.g., adhesion layer 204). At block 906, the process provides a heat sink layer (e.g., heat sink layer 206). In one aspect, at block 908, the process may additionally provide an interlayer/seed layer (e.g., interlayer 208). At block 910, the process provides a magnetic recording layer (MRL) (e.g., MRL 210). At block 912, the process provides a capping layer (e.g., capping layer 212).

At block 914, the process provides an overcoat layer (e.g., overcoat layer 214). At block 916, the process provides a lubricant layer, e.g., lubricant layer 218.

It is important to note that in alternative approaches, the lubricant layer formed above the protective overcoat may include any of the multidentate fluoroalkyl, fluoroalkenyl, perfluoroalkyl, or perfluoropolyether boundary lubricants described herein, singly and/or in any combination.

In various aspects, the lubricant layer can be formed on the magnetic recording medium, specifically on the protective overcoat, via a dip coating method. For instance, in one aspect the magnetic recording medium may be dipped into a lubricant bath including the multidentate perfluoropolyether boundary lubricant according to one or more aspects of the disclosure and a fluorocarbon solvent such as HFE7100 (hydrofluoroether) or VERTREL-XF (hydrofluorocarbon). After a predetermined amount of time, the magnetic recording medium may be pulled out from the lubricant bath at a controlled rate. The solvent may then evaporate, leaving behind a lubricant layer comprising the multidentate perfluoropolyether boundary lubricant. The bonding percentage is quantified by stripping the lubricated magnetic recording medium with the solvents used in the lubricant bath at various post-lube time periods.

The thickness of the lubricant layer may be tuned by controlling the submergence duration of the magnetic recording medium in the lubricant bath, the rate at which the magnetic recording medium is removed from the coating solution, and/or the concentration of the boundary lubricant (e.g. the lubricant according to one or more aspects of the disclosure) in the lubricant bath.

In one or more aspects, the concentration of lubricant in the lubricant bath may be in a range from about 0.001 g/L to about 1 g/L. In yet other aspects, the concentration of the lubricant in the lubricant bath may be selected so as to achieve a resulting lubricant layer with a thickness in a range from about less than or equal to about 10 nanometers (nm), or less than or equal to about 5 nm, or less than or equal to about 1 nm or from 0.1 nm to less than about 1 nm.

Likewise, the formation of the lubricant layer on the surface of the magnetic recording medium, specifically on the surface of the protective overcoat, is not limited to dip coating, but may also involve spin coating, spray coating, a vapor deposition, combinations thereof, or any other suitable coating process as would be understood by one having skill in the art upon reading the present disclosure.

It should be noted that methodology presented herein for at least some of the various aspects may be implemented, in whole or in part, in computer hardware, by hand, using specialty equipment, etc. and combinations thereof.

Moreover, any of the structures and/or steps may be implemented using known materials and/or techniques, as would become apparent to one skilled in the art upon reading the present disclosure.

In some aspects, the processes herein can perform the sequence of actions discussed above in a different order. In other aspects, the processes can skip one or more of the actions. In still other aspects, one or more of the actions are performed simultaneously. In some aspects, additional actions can be performed. For example, in one aspect, the process may include any additional actions needed to fabricate the magnetic recording layer structure.

In some aspects, the forming or deposition of such layers can be performed using a variety of deposition sub-processes, including, but not limited to physical vapor deposition (PVD), direct current (DC) sputter deposition, ion beam deposition, radio frequency sputter deposition, or chemical vapor deposition (CVD), including plasma enhanced chemical vapor deposition (PECVD), low pressure chemical vapor deposition (LPCVD) and atomic layer chemical vapor deposition (ALCVD). In other embodiments, other suitable deposition techniques known in the art may also be used.

The terms “on,” “above,” “below,” and “between” as used herein refer to a relative position of one layer with respect to other layers. As such, one layer deposited or disposed on/above or below another layer may be directly in contact with the other layer or may have one or more intervening layers. Moreover, one layer deposited or disposed between layers may be directly in contact with the layers or may have one or more intervening layers.

The above description is made for the purpose of illustrating the general principles of the present disclosure and is not meant to limit the inventive concepts claimed herein. Further, particular features described herein can be used in combination with other described features in each of the various possible combinations and permutations.

It should be noted that in the development of any such actual aspect, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the device, system and/or method used/disclosed herein can also comprise some components other than those cited.

Unless otherwise specifically defined herein, all terms are to be given their broadest possible interpretation including meanings implied from the specification as well as meanings understood by those skilled in the art and/or as defined in dictionaries, treatises, and the like.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 20 angstroms (Å) refers to a thickness of 20 Å+/−2 Å, e.g., from 18 Å to 22 Å in this example.

In the summary and this detailed description, each numerical value should be read once as modified by the term “about” (unless already expressly so modified), and then read again as not so modified unless otherwise indicated in context. Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used in the specification and claims, “near” is inclusive of “at.” The term “and/or” refers to both the inclusive “and” case and the exclusive “or” case, and such term is used herein for brevity. For example, a composition comprising “A and/or B” may comprise A alone, B alone, or both A and B.

Various components described in this specification may be described as “including” or made of certain materials or compositions of materials. In one aspect, this can mean that the component consists of the particular material(s). In another aspect, this can mean that the component comprises the particular material(s).

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. It is further noted that the term “over” as used in the present application in the context of one component located over another component, may be used to mean a component that is directly on another component and/or in another component (e.g., directly on a surface of a component or embedded in a component). Thus, for example, a first component that is over the second component may mean that (1) the first component is over the second component, but not directly touching the second component, (2) the first component is directly on (e.g., directly on a surface of) the second component, and/or (3) the first component is in (e.g., embedded in) the second component. The term “about ‘value X’”, or “approximately value X,” as used in the disclosure shall mean within 10 percent of the ‘value X’. For example, a value of about 1 or approximately 1 would mean a value in a range of 0.9-1.1. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range. In the disclosure various values (e.g., value X) may be specified, described and/or claimed. In one embodiment, it should be understood that the value X may be exactly equal to X. In one embodiment, it should be understood that the value X may be “about X,” with the meaning noted above.

While various aspects have been described above, it should be understood that they have been presented by way of example only, and not limitation. Thus, the breadth and scope of an aspect of the present invention should not be limited by any of the above-described exemplary aspects, but should be defined only in accordance with the following claims and their equivalents.

1. A lubricant comprising: a plurality of segments according to general formula (I), (II), or (III):
Re¹—Rb¹-Rc-Rb²—Re² (I);
Re¹—Rb¹—Re² (II); or
Re¹—Rb¹—(Rc-Rb²)ₘ-Re² (III);
wherein Rc is a divalent linking segment that optionally includes a first anchoring functional group engageable with a protective overcoat of a magnetic recording medium;
wherein each Rb¹ and Rb² independently comprises a chain segment comprising at least one of a fluoroalkyl ether moiety, a fluoroalkenyl ether moiety, a perfluoroalkyl ether moiety, a perfluoroalkenyl ether moiety, or a combination thereof;
wherein each of Re¹ and Re² independently comprises a group having a higher rotational energy barrier than that of CH₂, terminating with at least one second anchoring functional group engageable with the protective overcoat of the magnetic recording medium comprising —CH₂OCH₂(CH₂)ₙ(Ra)ₙ₋₁ or —OCH₂(CH₂)ₙ(Ra)ₙ₋₁, wherein Ra is the second anchoring functional group, m=2 and n=2-10.

2. The lubricant of claim 1, wherein the first and second anchoring functional groups independently each comprises at least one of B, Si, a pnictogen, a chalcogen, a halogen, —OR*, —NR*₂, —NR*—CO—R*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure.

3. The lubricant of claim 1, wherein the first and second anchoring functional groups each comprises a hydroxyl (—OH) moiety.

4. The lubricant of claim 1, wherein Re¹ and Re² independently comprises —OCF₂(CF₂)ₘ—O—CH₂ArRt, wherein Rt is —CH₂OCH₂(CH₂)ₙ(Ra)ₙ₋₁ or Rt is —OCH₂(CH₂)ₙ(Ra)ₙ₋₁, Ar is an aromatic group and Ra is the second anchoring functional group.

5. The lubricant of claim 1, wherein the group having a higher rotational energy barrier than that of CH₂ is an aromatic group.

6. The lubricant of claim 1, wherein the group having a higher rotational energy barrier than that of CH₂ is benzene or anisole.

7. The lubricant of claim 1, wherein the first and second anchoring functional groups independently comprises one or more of B, Si, a pnictogen, a chalcogen, a halogen, —OH, —NH₂, —NH—CO—H, —O—CO—H, —CO—O—H, —SeH, —TeH, —PH₂, —PO—(OH)₂, —O—PO—(OH)₂, —N=P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof, wherein q is 1 to 10.

8. The lubricant of claim 1, wherein each Ra is independently selected from the group consisting of:

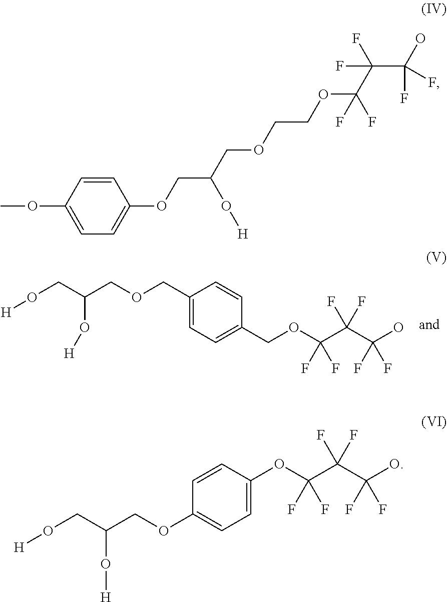

9. The lubricant of claim 1, wherein each Ra is independently selected from the group consisting of: 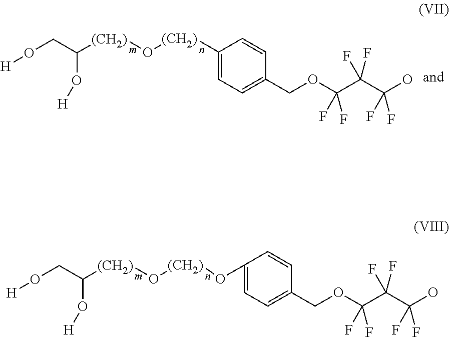
wherein n is 0 to 10 and m is 1 to 10.

10. A lubricant, which comprises the general formula (XVII): 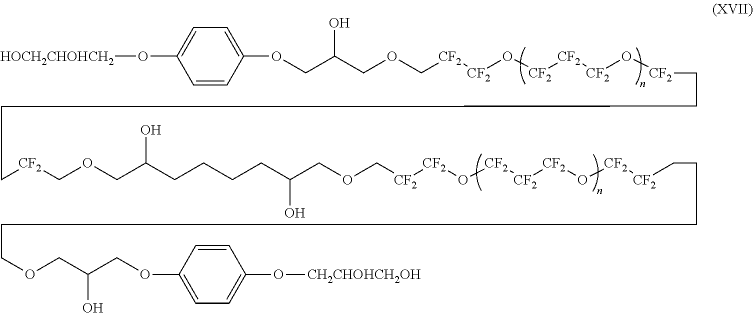
where n=1-10, the lubricant containing groups having a higher rotational energy barrier than that of CH₂.

11. The lubricant of claim 1, which comprises the general formula (XVIII): 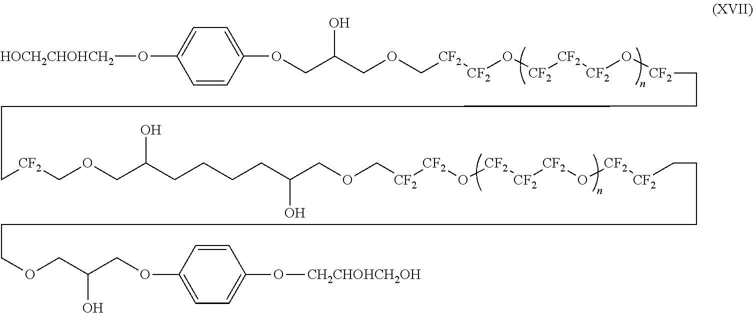
where n=1-10.

12. The lubricant of claim 1, wherein Rc comprises general formula (IXX): 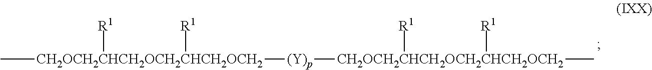
wherein each Y independently comprises:
(i) —CH₂—;
(ii) —CF₂—;
(iii) —CHF—;
(iv) —CF₂CF₂CF₂O(CF₂CF₂CF₂CF₂O)ₐCF₂CF₂CF₂—;
(v) —CF₂CF₂O(CF₂CF₂CF₂O)ₐCF₂CF₂—;
(vi) —CF₂CF₂O[CF(CF₃)CF₂O]ₐCF₂CF₂—;
(vii) —CF₂O(CF₂CF₂O)ₐ(CF₂O)_{b}CF₂—;
(viii) —CF₂O(CF₂CF₂O)ₐCF₂—;
or a combination thereof;
wherein each a is independently from 1 to 20,
wherein each b is independently from 1 to 20;
wherein p is from 1 to 20; and
wherein at least one R¹ is an anchoring functional group engageable with a protective overcoat of a magnetic recording medium, comprising B, Si, a pnictogen, a chalcogen, a halogen, —OR*, —NR*₂, —NR*—CO—R*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, and wherein two or more R* may join together to form a ring structure.

13. The lubricant of claim 1, wherein Rc, when present, comprises general formula (XX): 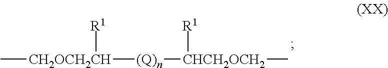
wherein each Q independently comprises:
(i) —CH₂—;
(ii) —CF₂—;
(iii) —CHF—;
(iv) —CF₂CF₂CF₂O(CF₂CF₂CF₂CF₂O)ₐCF₂CF₂CF₂—;
(v) —CF₂CF₂O(CF₂CF₂CF₂O)ₐCF₂CF₂—;
(vi) —CF₂CF₂O[CF(CF₃)CF₂O]ₐCF₂CF₂—;
(vii) —CF₂O(CF₂CF₂O)ₐ(CF₂O)_{b}CF₂—;
(viii) —CF₂O(CF₂CF₂O)ₐCF₂—;
or a combination thereof;
wherein each a, when present, is independently from 1 to 20,
wherein each b, when present, is independently from 1 to 20;
wherein n is from 1 to 20; and
wherein at least one R¹ is an anchoring functional group engageable with a protective overcoat of a magnetic recording medium, comprising B, Si, a pnictogen, a chalcogen, a halogen, —OR*, —NR*₂, —NR*—CO—R*, —O—CO—R*, —CO—O—R*, —SeR*, —TeR*, —PR*₂, —PO—(OR*)₂, —O—PO—(OR*)₂, —N=P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, and/or a heterocyclic C₂-C₅₀ radical, wherein two or more R* may join together to form a ring structure.

14. The lubricant of claim 13, wherein at least one R¹ comprises a hydroxyl moiety (—OH).

15. The lubricant of claim 1, wherein Rc, when present, comprises an ester functional group comprising general formula (XXI), (XXII), or a combination thereof: 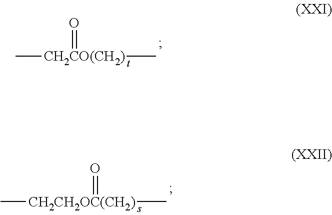
wherein t, when present, is from 1 to 20; and
wherein s, when present, is from 1 to 20.

16. The lubricant of claim 1, wherein Rb¹, and Rb² comprise the formula:
(iv) —CF₂CF₂CF₂O(CF₂CF₂CF₂CF₂O)ₐCF₂CF₂CF₂—;
(v) —CF₂CF₂O(CF₂CF₂CF₂O)ₐCF₂CF₂—;
(vi) —CF₂CF₂O[CF(CF₃)CF₂O]ₐCF₂CF₂—;
(vii) —CF₂O(CF₂CF₂O)ₐ(CF₂O)_{b}CF₂—; or
(viii) —CF₂O(CF₂CF₂O)ₐCF₂—;
or a combination thereof;
wherein each a is, independently from 1 to 20, and
wherein each b is independently from 1 to 20.

17. The lubricant of claim 1, comprising a weight average molecular weight from about 0.1 to 20 kiloDaltons (kDa).

18. A magnetic recording medium, comprising:
a magnetic recording layer on a substrate;
a protective overcoat on the magnetic recording layer; and
a lubricant layer comprising the lubricant according to claim 1 on the protective overcoat.

19. A data storage system, comprising:
at least one magnetic head;
a magnetic recording medium including the lubricant of claim 1;
a drive mechanism for positioning the at least one magnetic head over the magnetic recording medium; and
a controller electrically coupled to the at least one magnetic head for controlling operation of the at least one magnetic head.

20. A data storage system, comprising:
a slider comprising at least one magnetic head and an air bearing surface (ABS), wherein a lubricant according to claim 1 is disposed on the ABS; and
the magnetic recording medium including a magnetic recording layer;
wherein the slider is configured to write information to the magnetic recording layer using heat assisted magnetic recording (HAMR).

21. A lubricant comprising: a plurality of segments according to general formula (I), (II), or (III):
Re¹—Rb¹-Rc-Rb²—Re² (I);
Re¹—Rb¹—Re² (II); or
Re¹—Rb¹—(Rc-Rb²)ₘ-Re² (III);
wherein Rc is a divalent linking segment that optionally includes a first anchoring functional group;
wherein each Rb¹ and Rb² independently comprises a chain segment comprising at least one of a fluoroalkyl ether moiety, a fluoroalkenyl ether moiety, a perfluoroalkyl ether moiety, a perfluoroalkenyl ether moiety, or a combination thereof;
wherein each of Re¹ and Re² independently comprises a group having a higher rotational energy barrier than that of CH₂, terminating with at least one second anchoring functional group engageable with the protective overcoat of the magnetic recording medium comprising —CH₂OCH₂(CH₂)ₙ(Ra)ₙ₋₁ or —OCH₂(CH₂)ₙ(Ra)ₙ₋₁, wherein Ra is the second anchoring functional group, m=2 and n=2-10.
